(19) United States
(12) Patent Application Publication
(10) Pub. No.: US 2011/0278877 A1
(43) Pub. Date: Nov. 17, 2011

(54) CARRIAGE-TYPE CABIN

(76) Inventor: Sung Jin KIM, Pocheon-si (KR)

(21) Appl. No.: 13/069,247

(22) Filed: Mar. 22, 2011

(30) Foreign Application Priority Data
May 13, 2010 (KR) 10-2010-0044843

(51) Int. Cl. B60P 3/335

(52) U.S. Cl. 296/168

(57) ABSTRACT

Various exemplary embodiments of a carriage-type cabin are disclosed. One exemplary embodiment may include a chassis having wheels to allow movement, a hitch disposed in a rear side of the chassis to enable attachment to another vehicle, a floor plate disposed on the chassis, a cabin body disposed on the floor plate and forming an interior space therein where the cabin body includes an entry door and a window, and a staircase disposed in a front side of the chassis and configured to guide a user to conveniently ingress and egress through the entry door. The cabin body may include an internal frame disposed on the floor plate and forming a basic frame and an external frame disposed above the inner frame. The internal frame and the external frame may be spaced apart from each other so as to form an air passageway therebetween for allowing air to flow naturally. The cabin body may also include a support plate attached to the outside of the internal frame for blocking between an inner space and an outer space, an internal finishing material made of wood attached to the inner surface of the support plate, external finishing material made of wood attached to the external surface of the support plate so as to provide an environment-friendly look, and a canvas disposed over the external frame to block solar heat from directly reaching the internal frame.

### CROSS-REFERENCE TO RELATED APPLICATION

This application claims the benefit of priority under 35 U.S.C. §119(a) of Korean Patent Application No. 10-2010-0044843, filed on May 13, 2010, in the Korean Intellectual Property Office, the entire disclosure of which is incorporated herein by reference.

### BACKGROUND

1. Field

Various embodiments of the present disclosure relate to a carriage-type cabin. In particular, certain embodiments relate to a cabin having an appearance of a classic carriage, which may provide memories and excitement for a user, and certain structural improvements to a cabin body and stairs to provide a pleasant and comfortable lodging environment.

2. Description of Related Art

With improvements in economy and culture, there is a trend of increasing population who take prolonged trips using holidays or vacations. In particular, in order to enjoy long vacations without being limited by lodging options, people are turning to camping cars or trailers (e.g., caravan or towable vehicle) that are equipped with various lodging facilities.

Korean Patent Publication Nos. 2005-0036939 and 2004-0000371 and Korean Patent Nos. 0871633 and 0794475 disclose a variety of camping houses. However, these camping houses have disadvantages of not being able to provide unique experiences and excitement while providing a comfortable lodging space.

Moreover, there are various types of camps that provide outdoor living experience to students away from home. To accommodate such camps, there is a need for providing secured lodging spaces. In particular, tents are usually provided as a lodging option for outdoor camps, but tents are disadvantageous in that they are subject to weather and do not provide comfortable lodging.

### SUMMARY

Accordingly, there is a need for an improved cabin that may obviate or supplement one or more disadvantages or problems discussed above. Thus, various exemplary embodiments of the present disclosure may provide a cabin that has an external appearance of a classic carriage (e.g., a covered wagon such as a prairie schooner and a Conestoga wagon), which may provide a unique experience and excitement to a user. In addition, the cabin may provide a pleasant and comfortable lodging environment through structural improvements to the body of the cabin and stairs.

In the following description, certain aspects and embodiments will become evident. It should be understood that these aspects and embodiments are merely exemplary, and the invention, in its broadest sense, could be practiced without having one or more features of these aspects and embodiments.

To attain the advantages, as embodied and broadly described herein, one exemplary aspect may provide a carriage-type cabin comprising a chassis having wheels to allow movement, a hitch disposed in a rear side of the chassis to enable attachment to another vehicle, a floor plate disposed on the chassis, a cabin body disposed on the floor plate and forming an interior space therein where the cabin body includes an entry door and a window, and a staircase disposed in a front side of the chassis and configured to guide a user to conveniently ingress and egress through the entry door.

The cabin body may include an internal frame disposed on the floor plate and forming a basic frame and an external frame disposed above the inner frame. The internal frame and the external frame may be spaced apart from each other so as to form an air passageway therebetween for allowing air to flow naturally. The cabin body may also include a support plate attached to the outside of the internal frame for blocking between an inner space and an outer space, an internal finishing material made of wood attached to the inner surface of the support plate, external finishing material made of wood attached to the external surface of the support plate so as to provide an environment-friendly look, and a canvas disposed over the external frame to block solar heat from directly reaching the internal frame.

According to another exemplary aspect, the internal frame may comprise a plurality of lower support beams lodged perpendicularly onto an edge of the floor plate with a uniform interval, a horizontal support beam for connecting the plurality of lower support beams together, and a plurality of arc support beams each disposed above the horizontal support beam to form a shape of an arc and create a frame for the internal space.

In still another exemplary aspect, the external frame may comprise a plurality of middle support beams each disposed perpendicularly from the middle of each respective arc support beam, a plurality of arch support beams each having its ends fixed to the horizontal support beams and its middle portion fixed to the middle support beam, and a plurality of eave support beams each disposed in front of or behind the arch support beams, the ends of each of the eave support beams being attached to the horizontal support beams, each of the eave support beams protruding beyond the front or rear of the cabin body to form an eave.

In some exemplary aspects, the support plate of the cabin body may be made of a metal plate for maintaining hardness. According to another exemplary aspect, an insulation material may be disposed between the support plate and the internal finishing material, and a heat insulation material and a finishing fabric are placed in order between the support plate and the external finishing material.

According to still another exemplary aspect, the staircase may be attached to the chassis. For example, a bracket may be formed with the chassis, and a connector may be formed with a rear side of the staircase, where the bracket and the connector may be connected via a hinge pin and are rotatable with respect to the hinge pin, allowing the staircase to be laid onto the ground when placed horizontally and to be fixed against the cabin body with a rope or a string when lifted vertically.

In yet still another exemplary aspect, a support leg is rotatably disposed under a front side of the staircase and, when the staircase is placed horizontally, the support leg is rotated downwardly so that the front side of the staircase is supported by the support leg. Further, a support post capable of adjusting its length may be disposed under the front side of the chassis, and the rear side of the chassis that includes the hitch may protrude beyond the cabin body and be supported by the support post. In one exemplary aspect, the rear side of the chassis may be supported by a wood or a rock.

In accordance with another exemplary aspect, the interior space, when entering through the entry door, may comprise a bed disposed on the left side, a sofa disposed on the right side, a shelf disposed on a side opposite to the entry door, and a fireplace disposed above the shelf.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various embodiments consistent with the invention and, together with the description, serve to explain the principles of the invention.

FIG. 1 is a perspective view of a carriage-type cabin according to one exemplary embodiment of the present disclosure.

FIG. 2 is a side view of the carriage-type cabin shown in FIG. 1.

FIG. 3 is a partial perspective view of the carriage-type cabin of FIG. 1, illustrating an exemplary embodiment of a stair connecting portion.

FIG. 4 is a perspective view illustrating the frames of the carriage-type cabin, according to one exemplary embodiment.

FIG. 5 is a cross-sectional view of the inside of a cabin body according to one exemplary embodiment of the present disclosure.

FIG. 6 is a side view of the carriage-type cabin with its stairs folded up according to one exemplary embodiment.

### DETAILED DESCRIPTION

Reference will now be made in detail to the exemplary embodiments consistent with the present invention, examples of which are illustrated in the accompanying drawings. Wherever possible, the same reference numbers will be used throughout the drawings to refer to the same or like parts.

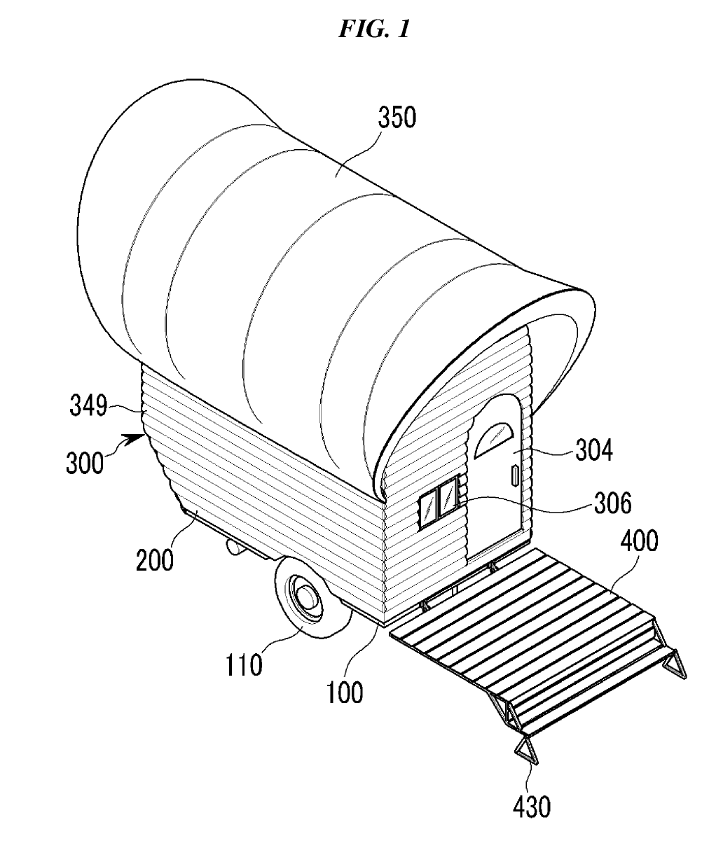

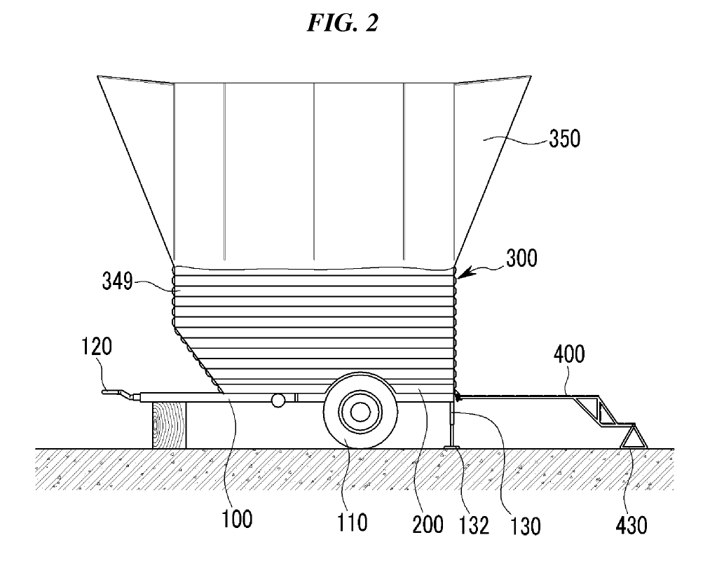

Referring to FIGS. 1-2, a carriage-type cabin, according to one exemplary embodiment consistent with the present disclosure, may comprise a chassis 100 with wheels 110 installed underneath to make it movable. A hitch 120 (e.g., a hook) may be disposed at the rear side of the chassis 100 allowing the cabin to connect to another vehicle. The cabin may be connected to another vehicle and used as mobile lodging. Alternatively or additionally, the cabin can be placed at a fixed location (e.g., a camp site) and be used as stationary lodging (e.g., a camp cabin or a pension house).

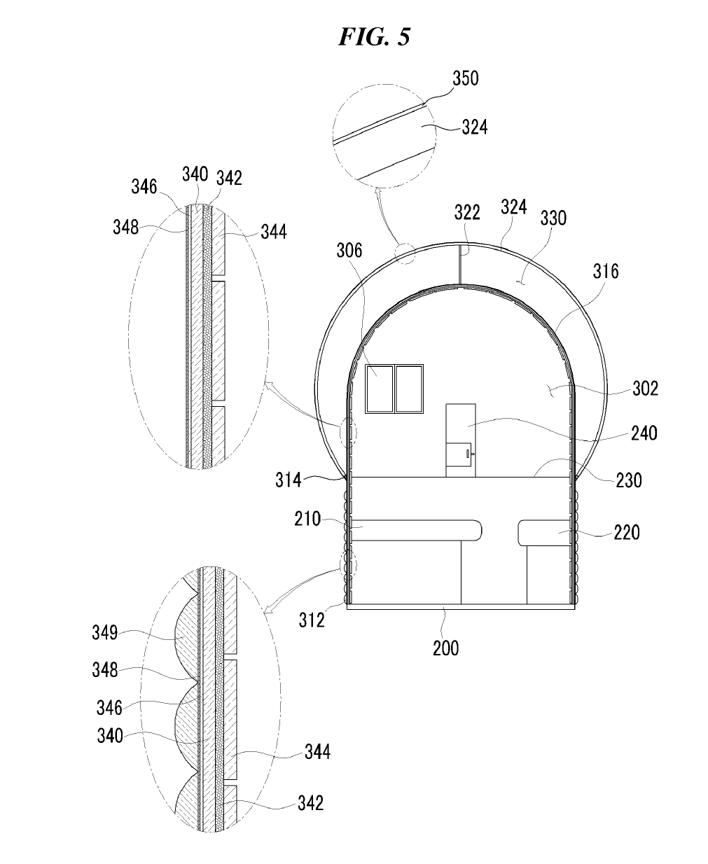

Disposed above the chassis 100 is a floor plate 200. The floor plate 200 may be made of a wooden material. A cabin body 300 comprising a roof and walls of the cabin is disposed above the floor plate 200. The cabin body 300 may have a shape of a carriage, as best shown in FIG. 1. An entry door 304 may be placed in the front side of the cabin body 300. Windows 306 may be placed in the front and/or back side of the cabin body 300. As best shown in FIG. 5, when entering an interior space 302 of the cabin body 300 through the entry door 304, a bed 210 may be installed on the left side and a sofa 220 on the right side. A shelf 230 may be installed on a side opposite to the entry door 304, and a fireplace 240 may be installed above the shelf 230.

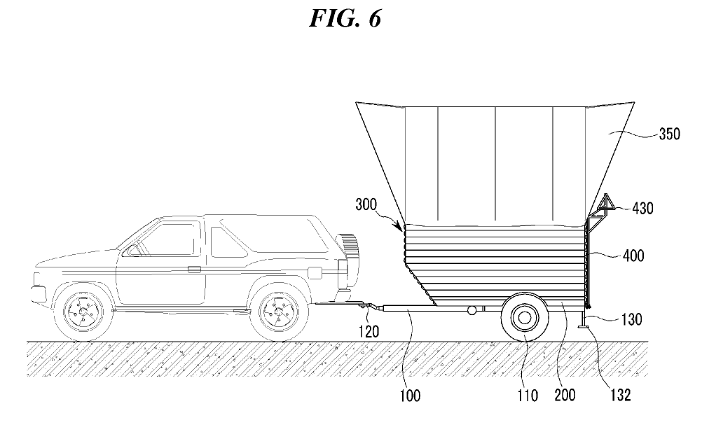

A staircase 400 may be disposed in the front side of the chassis 100. The staircase 400 may be configured to guide a user to conveniently ingress and egress through the entry door 304. The staircase 400 may be foldable such that it can be unfolded when the cabin is used on a surface and folded up against the cabin body 300, as shown in FIG. 6, when the cabin is being moved. When folded up against the cabin body 300, the staircase can be held stationary using a rope or chain.

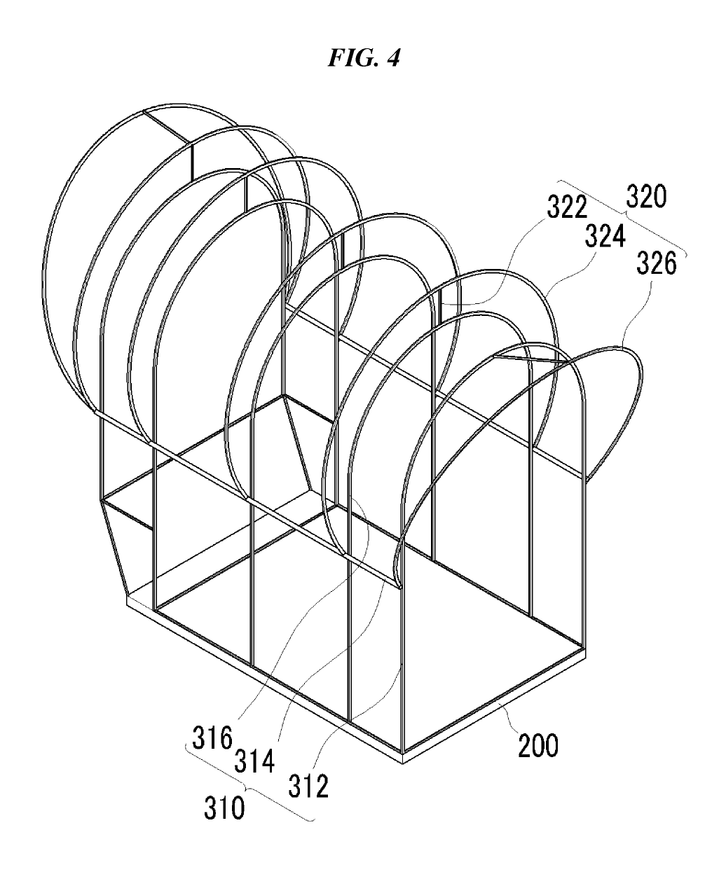

Referring to FIGS. 4 and 5, the cabin body 300, according to one exemplary embodiment consistent with the present disclosure, may comprise an internal frame 310 and an external frame 320. The internal frame 310, which forms the basic structural frame of the cabin body 300, may be disposed above the floor plate 200, and the external frame 320 may be disposed above the internal frame 310. The internal frame 310 and the external frame 320 are spaced apart from one another so as to form an air passageway 330 therebetween.

The internal frame 310 may comprise a plurality of lower support beams 312 extending perpendicularly from the edge of the floor plate 200. The lower support beams 312 may be disposed along the edge with a uniform interval. The internal frame 310 may also comprise one or more horizontal support beams 314 for connecting the plurality of lower support beams 312 together. The internal frame 310 may also comprise a plurality of arc support beams 316, each disposed above the horizontal support beams 314 and forming an arc to create a frame for an interior space 302.

The external frame 320 may comprise a plurality of middle support beams 322, each extending perpendicularly from the middle of the respective arc support beam 316, and a plurality of arch support beams 324, each having its ends fixed to the horizontal support beams 314 and its middle portion fixed to the respective middle support beam 322. The external frame 320 may further comprise one or more eave support beams 326 that are disposed in front of and/or behind the plurality of arch support beams 324. For example, as shown in FIG. 4, a frontal eave support beam 326 is disposed in front of the plurality of arch support beams 324, while a rear eave support beam 326 is disposed behind the plurality of arch support beams 324. With its ends attached to the horizontal beams 314, the frontal and rear eave support beams 326 each protrude forwardly and backwardly, respectively, beyond the frontal and rear planes of the cabin to form eaves of the cabin.

Accordingly, an air passageway 330 may be formed between the arc support beams 316 of the internal frame 310 and the arch support beams 324 of the external frame 320. Air flowing through the air passage 330 may prevent solar heat from penetrating the internal frame 310.

Attached to the outside of the internal frame 310 is a support plate 340 that may cut off air ventilation between inside and outside of the cabin. In some exemplary embodiments, the support plate 340 may comprise a metal plate to maintain the hardness.

On the internal surface of the support plate 340, an internal finishing material 344 may be attached. The internal finishing material 344 may be made of wood. An insulation material 342 may be disposed between the support plate 340 and the internal finishing material 344. The insulation material 342 may comprise Styrofoam. On the external surface of the support plate 340, an external finishing material 349 made of wood may be attached to give an environment-friendly look. An external insulation material 346 and a finishing fabric 348 may be placed between the support plate 340 and the external finishing material 349 to enhance heat insulation. In certain exemplary embodiments, the external insulation material 346 may be made of nonwoven fabric, felt, or any other customary materials. A canvas 350 may be disposed over the external frame 320 to prevent solar heat from directly reaching the support plate 340 of the internal frame 310.

Moreover, air flowing in the air passageway 330 between the internal frame 310 and the external frame 320 may stop the solar heat directed to the canvas 350 from penetrating through the interior space 302. Accordingly, overheating of the interior space 302 caused by solar heat during hot weather can be prevented. Similarly, the insulation material 342 and the external insulation material 346 may prevent warm air from discharged to outside during cold weather, thereby providing a pleasant interior space 302.

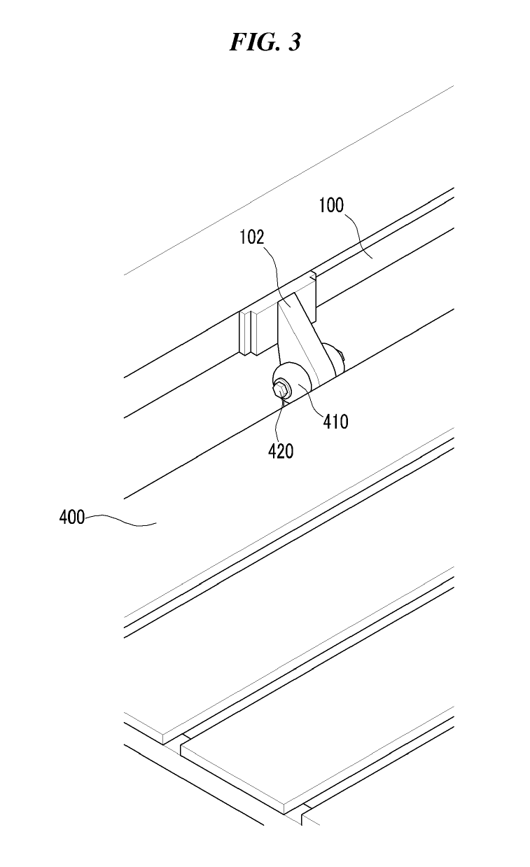

Now, with reference to FIG. 3, a staircase 400 attached to the chassis 100, according to one exemplary embodiment, will be described. As shown in FIG. 3, the staircase 400 may comprise a plurality of steps and its rear end may be connected to the front side of the chassis 100. A bracket 102 may be attached to or integrally formed with the chassis 100, and a connector 410 may be attached to the rear end of the staircase 400. The bracket 102 and the connector 410 may be connected via a hinge pin 420, allowing the staircase 400 to rotate with respect to the hinge pin 420. Accordingly, when the staircase 400 is rotated down to place it horizontally, the lower-most step of the staircase 400 is laid onto the ground, as best shown in FIG. 2. Conversely, when the staircase 400 is rotated up to place it vertically, the staircase 400 is configured to be fixed against the cabin 300 by, for example, a rope or chain, as shown in FIG. 6.

In some exemplary embodiments, a support leg 430 can be rotatably attached to a lower frontal part of the staircase 400. When the staircase 400 is placed horizontally, the support leg 430 can be rotated downwardly such that the front part of the staircase 400 is supported by the support leg 430 against the ground. By way of example only, the stairs 400 may comprise wooden panels attached to a metal frame, and the connector 410 may be disposed in the rear side of the metal frame. The support leg 430 may be rotatably connected to the front side of the metal frame via a pin. It should be understood that various connecting mechanisms described above are exemplary only. Any other suitable connecting mechanisms known in the art may be used alternatively or additionally.

The cabin may also include one or more support posts 130 that can be placed under the front portion of the chassis 100. The support posts 130 may be adjustable in height. For example, the support posts 130 may be adjustable in length as with conventional retractable antennae. A support feet 132 may be attached to the bottom of the support post 130 so as to provide stable support against the ground surface.

The rear portion of the chassis 100 that includes the hitch 120 may protrude beyond the cabin body 300 and be supported by a rock (e.g., a boulder), wood, tree, or the like, as shown in FIG. 2. Of course, the rear portion of the chassis 100 can be supported by one or more support posts 130 as well.

According to another aspect, an exemplary method of manufacturing a carriage-type cabin is described herein. First, a chassis 100 with wheels 110 is provided, and a floor plate 200 is installed on the chassis 100. An internal frame 310 is then installed along the edges of the floor plate 200, and an external frame 320 is welded onto the internal frame 310, leaving some space between the frames. Once the frames 310, 320 are completed, support plates 340 for blocking air ventilation are welded onto the both sides of the internal frame 310, and an insulation material 342 made of Styrofoam and an internal finishing material 344 made of wood are sequentially attached to the internal surface of the support plates 340 to finish the interior.

An external insulation material 346, such as felt, and a finishing fabric 348 are attached to the external surface of the support plates 340, and all external surface except the portions installed with the external frame 320 are attached with an external finishing material 349 made of wood so as to provide an environment-friendly look. When installing support plates 340, finishing materials, and insulation materials to the internal frame 310, spaces may be allotted for installing an entry door 304 and window 306. The entry door 304 and window 306 may then be installed in the allotted space to permit ingress/egress and air ventilation. A canvas 350 may then be disposed over the external frame 320, completing the cabin body 300.

Once the cabin body 300 is completed, a staircase 400 is installed in the front portion of the chassis 100 to allow a user to comfortable access the entry door 304. The staircase 400 may be rotatably attached to a hinge pin 420 so that it can rotate to be laid onto the ground surface or folded up against the cabin body 300 and be held stationary by a rope or chain.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A carriage-type cabin comprising:
a chassis having wheels to allow movement;
a hitch disposed in a rear side of the chassis to enable attachment to another vehicle;
a floor plate disposed on the chassis;
a cabin body disposed on the floor plate and forming an interior space therein, the cabin body comprising an entry door and a window; and
a staircase disposed in a front side of the chassis and configured to guide a user to conveniently ingress and egress through the entry door,
wherein the cabin body comprises:
an internal frame disposed on the floor plate and forming a basic frame;
an external frame disposed above the inner frame, the internal frame and the external frame being spaced apart from each other so as to form an air passageway therebetween for allowing air to flow naturally;
a support plate attached to the outside of the internal frame for blocking between an inner space and an outer space;
an internal finishing material made of wood attached to the inner surface of the support plate, and external finishing material made of wood attached to the external surface of the support plate so as to provide an environment-friendly look; and
a canvas disposed over the external frame to block solar heat from directly reaching the internal frame.

2. The carriage-type cabin according to claim 1, wherein:
the internal frame comprises:
a plurality of lower support beams lodged perpendicularly onto an edge of the floor plate with a uniform interval;
a horizontal support beam for connecting the plurality of lower support beams together; and
a plurality of arc support beams each disposed above the horizontal support beam to form a shape of an arc and create a frame for the internal space;
the external frame comprises:
a plurality of middle support beams each disposed perpendicularly from the middle of each respective arc support beam;
a plurality of arch support beams each having its ends fixed to the horizontal support beams and its middle portion fixed to the middle support beam; and
a plurality of eave support beams each disposed in front of or behind the arch support beams, the ends of each of the eave support beams being attached to the horizontal support beams, each of the eave support beams protruding beyond the front or rear of the cabin body to form an eave,
the support plate of the cabin body is made of a metal plate for maintaining hardness,
an insulation material is disposed between the support plate and the internal finishing material, and
a heat insulation material and a finishing fabric are placed in order between the support plate and the external finishing material.

3. The carriage-type cabin according to claim 1, wherein:
the staircase is attached to the chassis,
a bracket is formed with the chassis, and a connector is formed with a rear side of the staircase, the bracket and the connector being connected via a hinge pin and being rotatable with respect to the hinge pin, allowing the staircase to be laid onto the ground when placed horizontally and to be fixed against the cabin body with a rope or a string when lifted vertically,
a support leg is rotatably disposed under a front side of the staircase and, when the staircase is placed horizontally, the support leg is rotated downwardly so that the front side of the staircase is supported by the support leg,
a support post capable of adjusting its length is disposed under the front side of the chassis, and the rear side of the chassis that includes the hitch protrudes beyond the cabin body and be supported by the support post, and
the rear side of the chassis is supported by a wood or a rock.

4. The carriage-type cabin according to claim 1, wherein, when entering through the entry door, the interior space comprises a bed disposed on the left side, a sofa disposed on the right side, a shelf disposed on a side opposite to the entry door, and a fireplace disposed above the shelf.
